(19) United States
(12) Patent Application Publication
(10) Pub. No.: US 2010/0223742 A1
(43) Pub. Date: Sep. 9, 2010

(54) AIR INJECTION TYPE PORTABLE DENTAL FLOSSES

(76) Inventor: So Dae Kang, Seoul (KR)

Correspondence Address: CHRISTOPHER PAUL MITCHELL, 888 16TH ST., NW, SUITE 800, WASHINGTON, DC, 20006, US

(21) Appl. No.: 12/681,619

(22) PCT Filed: Oct. 9, 2008
(86) PCT No.: PCT/KR08/05944

§ 371 Date: Apr. 2, 2010

(30) Foreign Application Priority Data
Oct. 9, 2007 (KR) 10-2007-0101697

(51) Int. Cl. A46B 13/00; A61C 15/00

(52) U.S. Cl. 15/22.1

(57) ABSTRACT

An air injection portable inter-dental toothbrush can be devised consisting of: driving section (10), including air injection pan (14), filter (15) for removing foreign aerial substance from outside, pan motor (16) for bringing in air and supplying it to air injection pan (14), battery (18) as a power for driving the pan and a battery still attached bedding (19); cleaning section (20), including cleansing fluid inlets and hose (24) which is composed of a container (21) for keeping cleansing fluid, where the cleansing fluid container (21) is connected to the hose while the other end of the latter being attached to the center of the gravity so that the fluid inlets and hose can infuse cleansing fluid no matter how the container's position changes, a valve (26) which can control cleansing fluid flow, a stopper (28) by which cleansing fluid being refilled or replaced; injecting section (30), including injecting nozzle 1 (31) where air brought in by driving section (10) and cleansing fluid supplied by cleaning section (20) blending and being injected; next to which inter-dental toothbrush section (40), including an outlet (43) for discharging air and cleansing fluid, holes (44) in plural numbers for injecting air and cleansing fluid perpendicularly and aslant, injection nozzle 2 (46a, 46b) with toothbrush bristle stuck for injecting.

### TECHNICAL FIELD

An Air Injection Type Portable Dental Flosses, by using inter-dental toothbrush removing sediment, meanwhile by driving air cleaner device and inject cleansing fluid removing bacteria cause oral diseases and sterilizing, and portable.

### BACKGROUND ART

Drawing 1 shows structure of usual portable dental cleansing fluid injection device, where No. 1 is body, No. 2 cover, No. 4 nozzle, No. 5 cleansing fluid and No. 6 nozzle hole. When pressing the body (1), cleansing fluid (5) is injected into teeth and in order to facilitate the injection, the nozzle (4) bends as a nearly right angle at the top. (this was registered as a patent on a new device with NO. 20-0432180, Nov. 23, 2006.).

However, usual portable dental cleansing fluid injection device fails to remove food scraps and other sediments in teeth, which is the very cause to bad breath and oral diseases.

As a result, inter-dental toothbrush is increasingly getting used for removing food scraps in teeth but it would be very inconvenient when moving outside. Especially for women or those who prefer cleanness, looking for a good place and tool to brush their teeth is really a problem when they are outside.

Usual inter-dental toothbrush often fails to remove sediments in teeth completely even though it can scratch them out and the brush would not work well if getting washed too much.

### DISCLOSURE OF INVENTION

### Technical Problem

For resolving the problems above, we promote this invention. Our purposes are,

1. Developing air injection portable inter-dental toothbrush, a new inter-dental toothbrush for removing the sediments in teeth or sterilizing, in which an air injection device is adopted for infusing air to facilitate sediments removing and cleansing fluid is injected together with air under Bernoulli principle and air pressure other than water pump.

2. Offering small size air injection portable inter-dental toothbrush, insuring your oral hygiene anywhere.

3. Promoting portable inter-dental toothbrush with diaphragm which can enhance cleaning effect by increasing air flow and air pressure while deducing noise.

### Technical Solution

For achieving purposes mentioned before, an air injection portable inter-dental toothbrush can be devised consisting of: driving section (10), including air injection pan (14), filter (15) for removing foreign aerial substance from outside, pan motor (16) for bringing in air and supplying it to air injection pan (14), battery (18) as a power for driving the pan and a battery still attached bedding (19); cleaning section (20), including cleansing fluid inlets and hose (24) which is composed of a container (21) for keeping cleansing fluid, where the cleansing fluid container (21) is connected to the hose while the other end of the latter being attached to the center of the gravity so that the fluid inlets and hose can infuse cleansing fluid no matter how the container's position changes, a valve (26) which can control cleansing fluid flow, a stopper (28) by which cleansing fluid being refilled or replaced; injecting section (30), including injecting nozzle 1 (31) where air brought in by driving section (10) and cleansing fluid supplied by cleaning section (20) blending and being injected; next to which inter-dental toothbrush section (40), including an outlet (43) for discharging air and cleansing fluid, holes (44) in plural numbers for injecting air and cleansing fluid perpendicularly and aslant, injection nozzle 2 (46a, 46b) with toothbrush bristle stuck for injecting.

That driving section and cleaning section be attached by male and female screw is advised, for free separation and connection.

That nozzle section and toothbrush section be attached by male and female screw is advised, for free separation and connection.

That the speed of pan motor in driving section be devised to 3 adjustable levels is advised.

That plane injection type nozzle be used in toothbrush section is advised.

### BRIEF DESCRIPTION OF DRAWINGS

FIG. 1: Structure of usual portable dental cleansing fluid injector

FIG. 2: Outward form of air injection portable inter-dental toothbrush in working plan 1 of this invention

FIG. 3: Oblique view of air injection portable inter-dental toothbrush in working plan 1 of this invention

FIG. 4: Oblique view of inner structure of driving section in drawing 3

FIG. 5: Oblique view of inner structure of driving section in drawing 3

FIG. 6: Sectioned drawing of inner structure of cleaning section

FIG. 7: Illustration of structure of nozzle section and toothbrush section connected to the upper end of driving section in drawing 3

FIG. 8: Illustration of using plane injection nozzle in toothbrush section in working plan 1

FIG. 9: Oblique view showing structure of portable inter-dental toothbrush with diaphragm in working plan 2 of this invention

FIG. 10: Working plan 3 of this invention

FIG. 11: Sectioned structure of diaphragm

FIG. 12: Connecting part of motor (16), decelerating gear (161), crankshaft (84), coupling rod (841) and diaphragm (82)

FIG. 13: Air inlet of cleansing container (92)

FIG. 14: Injection nozzle 1 (93)

FIG. 15: Drawing of portable inter-dental toothbrush with particles storage tube (210) in working plan 4 of this invention

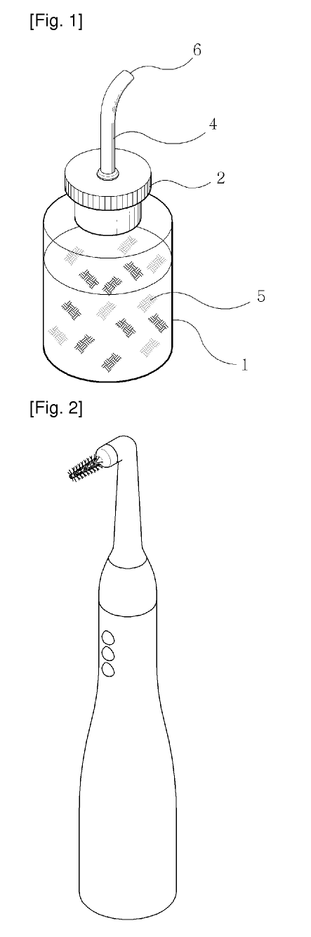

<Explanation of Essential Reference Numerals in Crawings>

10, 80: driving section 12, 32: male screw

13, 23: Fallopian path 14: air injection pan

15: filter 15a, 62, 62a: air inlet

16, 16a: motor

17: speed (H, M, L): motor adjustment switch (heavy, medium, light)

18: battery 19: battery still attached bedding

20: cleaning section 21, 42: cleansing fluid container

22, 42: female screw

26: cleansing fluid flow controlling valve

28, 44: cleansing fluid refilling stopper

30, 90: nozzle section 34, 93: injecting nozzle 1

40: (inter-dental) toothbrush section 43: outlet

44: toothbrush section holes 46a, 46b, 94: injecting nozzle 2

50: plane injecting nozzle 52, 52a: air outlet

56: connecting part of male and female screw

82, 82a: diaphragm

100: air injection portable inter-dental toothbrush

### MODE FOR THE INVENTION

4 desirable working plans following this invention will be introduced below in details by showing drawings.

Working Plan 1

FIG. 2: Outward form of air injection portable inter-dental toothbrush in working plan 1 of this invention

FIG. 3: Oblique view of air injection portable inter-dental toothbrush in working plan 1 of this invention

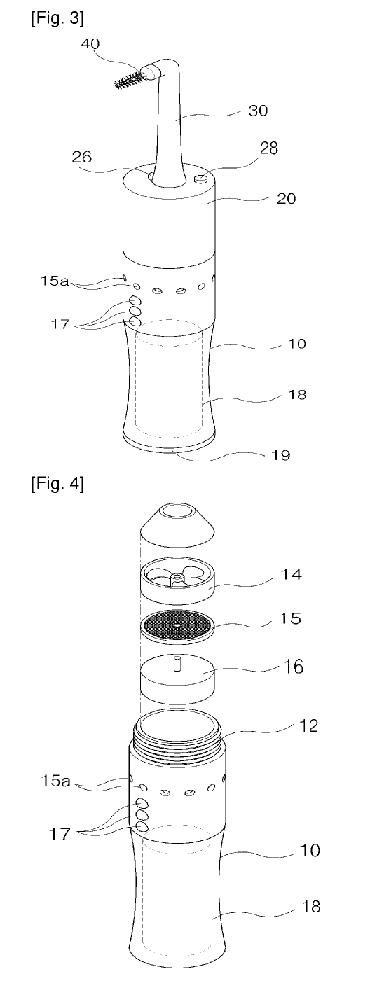

FIG. 4: Oblique view of inner structure of driving section in FIG. 3

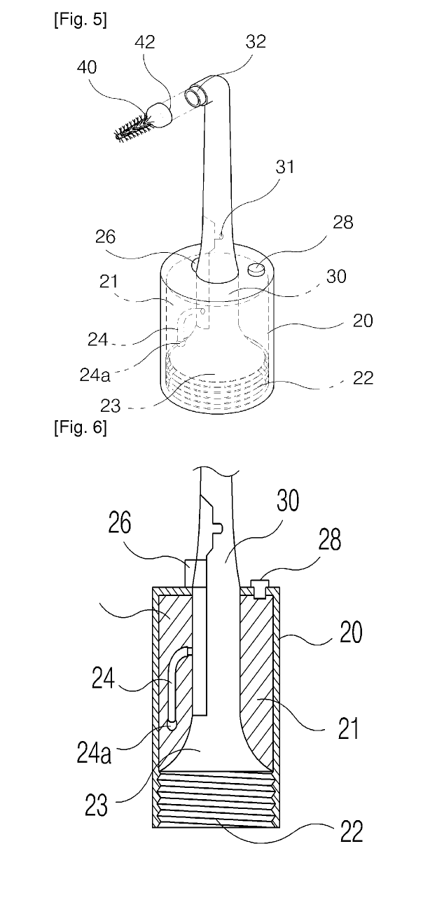

FIG. 5: Oblique view of inner structure of driving section in FIG. 3

FIG. 6: Sectioned view of inner structure of cleaning section

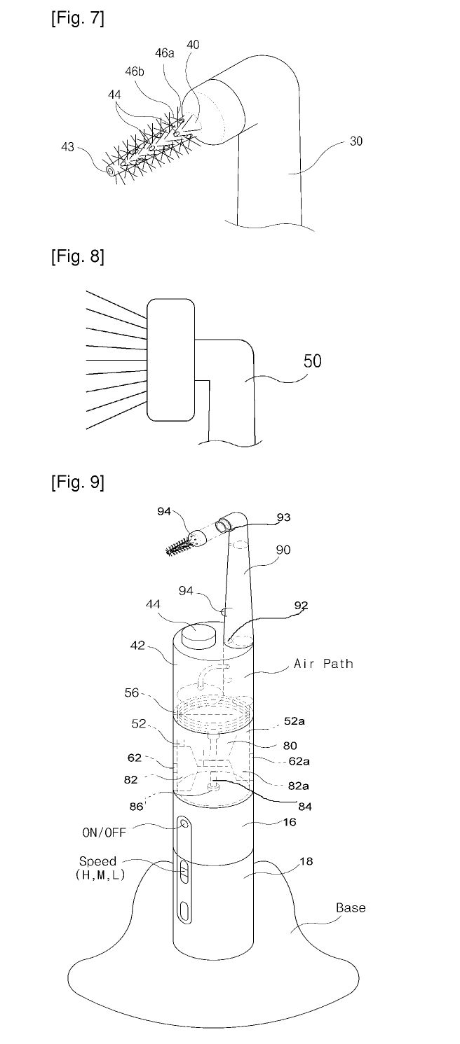

FIG. 7: Illustration of structure of nozzle section and toothbrush section connected to the upper end of driving section in FIG. 3

FIG. 8: Illustration of using plane injection nozzle in toothbrush section in working plan 1

In FIG. 3, No. 10 is driving section, over which is No. 20 cleaning section that can be separated and connected with driving section (10) freely. No. 30 is nozzle section (30) connecting to the upper end of cleaning section (20) and acting as the passage for injecting air and cleansing fluid, while No. 40 remarks inter-dental toothbrush section of injection.

Just as FIGS. 3 and 4 showing, driving section (10) of air injection portable inter-dental toothbrush in this invention consists of air injection pan (14), filter (15) for removing foreign aerial substance from outside, pan motor (16) for bringing in air and supplying it to air injection pan (14), battery (18) as a power for driving the pan and a battery still attached bedding (19). On outer surface of driving section are air inlets in plural number for bringing in air outside the pan motor (16). And a motor adjustment switch (17) is adopted so that the users can adjust the speed of injection to heavy, medium and light three levels.

In FIGS. 3, 5 and 6, cleaning section (20) of air injection portable inter-dental toothbrush in this invention consists of cleansing fluid inlets and hose (24) which is composed of a container (21) for keeping cleansing fluid, where the cleansing fluid container (21) is connected to the hose while the other end of the latter being attached to the center of the gravity so that the fluid inlets and hose can infuse cleansing fluid no matter how the container's position changes, a valve (26) which can control cleansing fluid flow and a stopper (28) by which cleansing fluid being refilled or replaced.

The kind of cleansing fluid is not limited, while those both able to sterilize and offering fragrance such as xylitol may do favor to increase consumption. Also, sterilized or clean drinking water can also be used. However, the water with high viscosity should be avoided for it may have difficulty being injected.

Users can infuse cleansing fluid to cleansing fluid inlets and hose and inject it into the mouth while adjusting the fluid flow by cleansing fluid flow controlling valve.

Also users can refill or replace certain ingredient by uncovering the stopper (28) and infusing the very ingredient.

Injecting section (30) of air injection portable inter-dental toothbrush in this invention consists of injecting nozzle 1 (31) where air brought in by driving section (10) and cleansing fluid supplied by cleaning section (20) blending and being injected.

Injecting nozzle 1 (31) acts under Bernoulli principle or air pressure, which means how much fluid being injected will be determined by speed and intensity of air flow. As a result, it becomes feasible by using the motor adjustment switch (17) cleansing fluid flow being injected can be controlled. In our invention, we used very flexible plastic material for injecting nozzle, while any other materials that would not contaminate cleansing fluid and can control air flow and injecting speed will be qualified.

At the end of nozzle section (30) is a male screw (32) while on toothbrush section next to nozzle section a female screw (42), by twisting up and off these two nozzle and toothbrush sections can connect with and separate from each other freely. So in case the toothbrush is clogged and fails to inject or inject too much, users can easily check it by separating nozzle and toothbrush sections.

Inter-dental toothbrush section (40) of air injection portable inter-dental toothbrush in this invention consists of an outlet (43) for discharging air and cleansing fluid, holes (44) in plural numbers for injecting air and cleansing fluid perpendicularly and aslant and injection nozzle 2 (46a, 46b) with toothbrush bristle stuck for injecting.

Here, the outlet (43) is for discharging air and the cleansing fluid mixture mentioned above.

There are holes in plural number on toothbrush section, of which some are perpendicular to inject cleansing fluid perpendicularly and others are slope, in order that cleansing fluid can reach anywhere and insure the effect of the teeth cleaning.

And, injecting nozzle 2 (46a, 46b) is not just used as an inter-dental toothbrush but also with cleansing fluid being injected from toothbrush bristle, which can facilitate using.

In our invention, end of the inter-dental toothbrush section (40) is leaving open as a hole tiny enough for injecting only a spot of fluid, however, there is no matter to use perpendicular and slope holes (44) on inter-dental toothbrush section only but plugging up the end hole, and vice versa.

And in our invention we adopted a bristle-stuck inter-dental toothbrush section, which can take advantage of air injection effect, while a model without bristle is also available.

By using air injection portable inter-dental toothbrush (100) made following this invention users can improve the effect of their teeth brushing by taking advantage of inter-dental toothbrush and cleansing fluid injector. Particularly, this kind of air injection inter-dental toothbrush (100) is available for producing as a small and portable type, which enables people in moving, restaurant or other contaminative places to brush their teeth easily.

Also, dental floss section (40) can be replaced by a plane injection nozzle (50, FIG. 8), which can also clean teeth or tongue besides inter-dental cleaning. And women may use it as moisturizer injector by directly putting moisturizer to the cleansing fluid container (21) through the stopper (28), or replacing the whole the container for other containers with fluid inlets and hose (24).

Working Plan 2

Working plan 2 will be introduced below by showing FIG. 9.

FIG. 9 is the oblique view of portable inter-dental flosses with diaphragm in working plan 2 of this invention. For common parts in both working plan 1 and 2, the same numbers are used except when changing is necessary for explaining the special structure and function in working plan 2.

In FIG. 9, No. 80 is driving section and No 82, 82a is diaphragm which brings in and discharges air by back-and-forth motion led by No. 84 crankshaft. No. 86 is a roll shaft for transferring power of the motor (16). And No. 62, 62a remarks air inlet, No. 52, 52a air outlet.

No. 90 remarks nozzle section and No. 93 is injecting nozzle section 1, No. 94 injection nozzle section 2. And Speed (H, M, L) is used to remark adjustment switch of motor speed.

Then we will turn to the function principle of the portable dental flosses with diaphragm in working plan 2.

First, let's explain structure of the diaphragm and crankshaft which initiates diaphragm's motion.

Diaphragm here consists of a rubber-film-stuck board with air inlet and outlet. Meanwhile side of the board is covered for being kept centripetally. And the middle part of diaphragm is made protuberantly in order to connect it to the crankshaft easily. Therefore, in the view of roll shaft (86), also center of the motor, certain part of the crankshaft is set off-centered and insures continuing rolling motion.

Second, let's see how the air-inflowing diaphragm functions.

Attach crankshaft (84) and diaphragm (82, 82a) by inserting crankshaft into holes on diaphragm's connecting section in a right angle, making sure that the rotative motion can transfer to back-and-forth motion freely. When the power switch is on and motor (16) rotates, diaphragm initiated by crankshaft (84) begins to move back-and-forth quickly. During moving back-and-forth, when diaphragm goes to top, inlet valve of the board opens and air flows in. On other hand, when diaphragm moves to the board the outlet valve opens, air flows out and air pressure forms.

Portable dental floss with diaphragm introduced above following this invention functions as follows.

First, the driving section (80) consists of moving crankshaft which is connected to roll shaft (86) of motor and inserted into diagram, at least a couple air inlet (62, 62a) and outlet (52, 52a) bringing in and discharging air, motor (16a) for bringing in air from outside and battery (18) to drive the motor. The driving section functions by the crankshaft, which changes motor s rotative motion to back-and-forth motion, and more than 1 or 2 diaphragms. In our invention we used 2 diaphragms, but 1 or more is possible. Using more will not be noisier; however, the problem of battery capacity should be considered since this invention is supposed to be a portable device.

Cleaning section in working plan 2 is the similar with that in working plan 1, including cleansing fluid inlets and hose (24) which is composed of a container (21) for keeping cleansing fluid, where the cleansing fluid container (21) is connected to the hose while the other end of the latter being attached to the center of the gravity so that the fluid inlets and hose can get in cleansing fluid no matter how the container's position changes; air inlet (92) on cleansing fluid container for forming air pressure in the container; a valve (94) which can control cleansing fluid flow and a stopper (44), by which cleansing fluid can be replaced or refilled, air flowing into the cleansing fluid container can be adjusted, or the fluid can be kept from flowing out. Make sure that air inlet (62, 62a) and outlet (52, 52a) on driving section and air path which will be introduced next be well set up for cleansing fluid flowing smoothly.

Nozzle section (90) consists of injecting nozzle 1 (93), a path for air and cleansing fluid brought in by diagram's back-and-forth motion, where the cleansing fluid from cleaning section being compressed and injected; injecting nozzle 2 (94), an air-and-fluid injecting device on the end of nozzle section; and air path on inner side of nozzle section for air flowing in.

When injecting nozzle 1 functions, cleansing fluid is raised up by air pressure, passing through the air path into the nozzle mixed with air, compressed and finally injected by injecting nozzle 2. The air path here is the main passage for air supplied by diaphragm, and in air path there is a small air inlet pine for producing air pressure in cleansing fluid container and supply fluid to nozzle 1. Better to penetrate this small air inlet pine separately with cleansing fluid path through upper section of cleansing fluid container and connect it with the stopper so air flow can be adjusted by the stopper and flowing out of fluid can be avoided.

And driving and cleaning sections are advised to be connected by male and female screw in order that they can combine and separate with each other freely. The position of the male and female screws doesn't matter once separation is possible.

A pocket size, noise and shake reduction are possible for this diaphragm-included portable dental flosses following our invention.

Working Plan 3

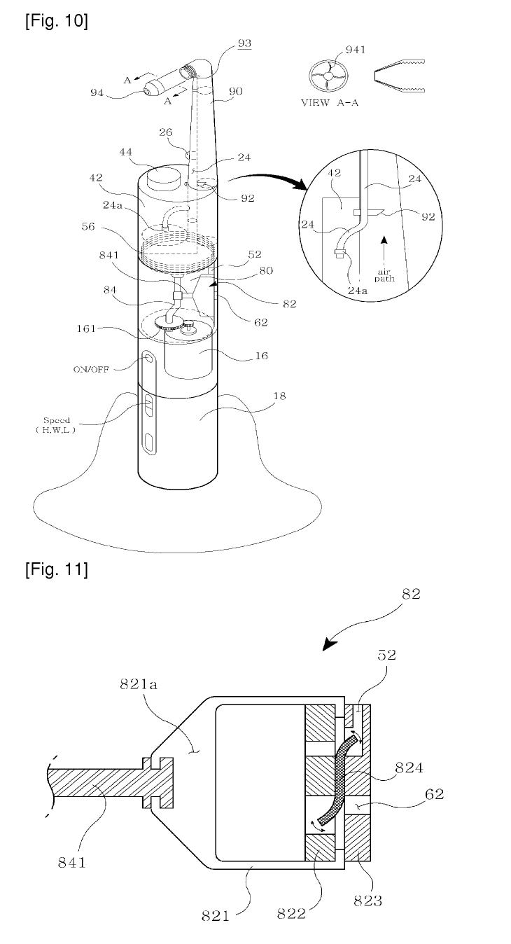

FIG. 10 shows the whole structure of working plan 3, in which motor (16), battery (18) and diaphragm (82) are included as in FIG. 9.

Diaphragm (82) changes motor(16)'s rotative motion to back-and-forth motion, bringing in air outside through air inlet (62), compressing and discharging air through air outlet (52). Then the compressed air from diaphragm flows into nozzle section (90).

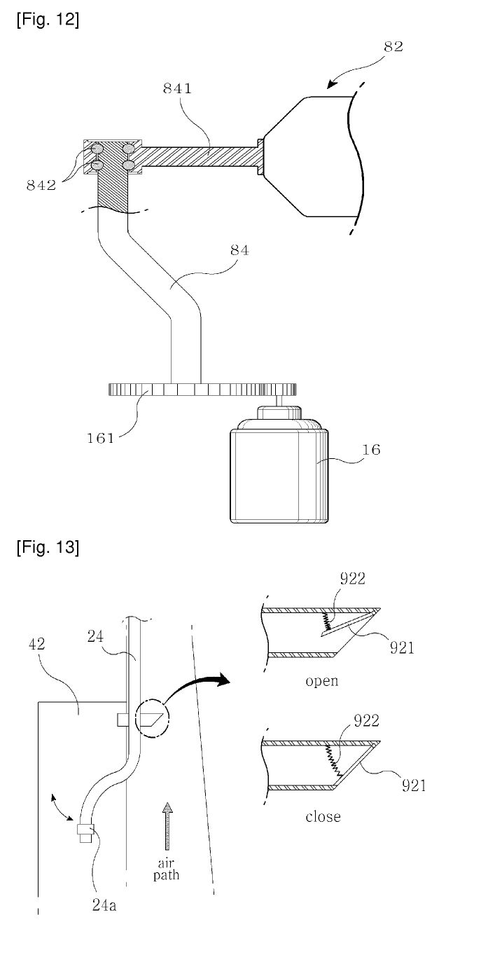

FIG. 11 is diaphragm (82)'s sectioned FIG. and FIG. 12 shows connecting section between motor(16) and diaphragm. According to FIGS. 11 and 12, a decelerating gear (161) is adopted to slow down rotation of the motor.

Crankshaft (84) is with one end fixed to decelerating gear (161), functioning as the latter's roll shaft and eccentricity. A coupling rod is adopted, with one end connected to crankshaft movably and the other fixed to diaphragm film.

That a bearing (842) be set up at the connecting section of the crankshaft and coupling rod is advised, for it may minimize friction and insure durability. There is no particular requirement on bearing's type or shape but size of product need to be considered.

Crankshaft and decelerating gear form an eccentricity. Once the gear rotates, crankshaft rotates, and coupling rod subsequently starts pulling and pushing diaphragm film.

As FIG. 11 showing, diaphragm (82) includes diaphragm film (821), inner cover (822), outer cover (823) and gate film (824), of which inner and outer covers, attaching to gate film, are fixed to body of portable dental floss and cover the open end of diaphragm film.

When the coupling rod pulls diaphragm film, within the film there will be vacuum, the gate film closes air outlet and opens air inlet, then air flows into diaphragm film. On the other hand, when the coupling rod pushes diaphragm film, within the film air will be compressed air, gate film closes air inlet and opens air outlet and the compressed air flows out to nozzle section.

That the connecting part of soft-material-made diaphragm film (821) and coupling rod is thicker than other part is a feature of this invention, which can maximize the volume expansion or compression of diaphragm film and produce compressed air more efficiently.

As a flowing-out path for compressed air, nozzle section has an air outlet (52) on the bottom, and injecting nozzle 1 where compressed air and cleansing fluid are mixed.

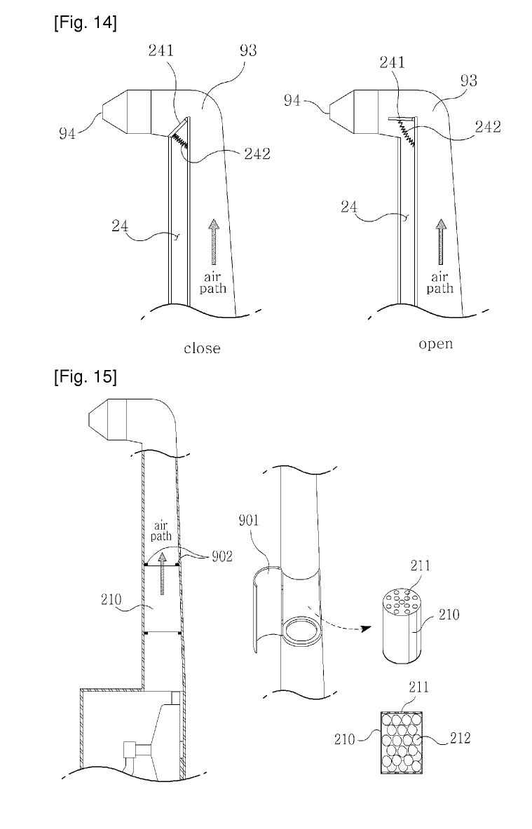

As FIG. 14 showing, injecting nozzle 1 (93) is on the upper part of the cleansing fluid hose (24), where cleansing fluid raised up through the hose and compressed air raised up through nozzle section are mixed. In case there is no compressed air available in the upper part of the hose, it's necessary to adopt block board 2 (241) that can block cleansing fluid hose automatically by using spring 2 (242).

So when the diaphragm is not working, blockboard 2 can block the outlet of cleansing fluid hose to keep the fluid from flowing out.

When the compressed air passes through injecting nozzle so fast that the air pressure it produced outside block board 2 is stronger than that in cleansing fluid hose, once the gap gets bigger than elastic force of spring 2, block board 2 will be opened.

Cleansing fluid container is next to nozzle section and supplies cleansing fluid in store to cleansing fluid hose when diaphragm functions.

The cleansing fluid hose has its lower part in cleansing fluid container and upper part penetrating nozzle section toward injecting nozzle 1.

As FIG. 13 showing, since the center of gravity leans to lower part of cleansing fluid hose, the hose bends to the lower part and cleansing fluid can flow steadily into the hose no matter whether cleansing fluid container is slope or not.

Air inlet on cleansing fluid container (92) functions as an air path to connect cleansing fluid container and nozzle section and infuses part of compressed air from nozzle section into cleansing fluid container. Only by interacting with some compressed air can cleansing fluid be discharged smoothly though the hose.

As FIG. 13 showing, where the air inlet on cleansing fluid container is attached to nozzle section, the upper part is more projecting to nozzle section, which facilitates compressed air flowing in. In case there is no compressed air available in storage, it's necessary to adopt block board 1 (922) that can block air inlet on cleansing fluid container automatically by using spring 1 (921).

As a result, when diaphragm is not working, air inlet on cleansing fluid container closes and cleansing fluid stored in the container will be kept from flowing out to nozzle section. Once compressed air given, block board 1 (921) is pushed up open.

Injecting nozzle 2 is connected to the top of nozzle section, of which the inner path's cross section decreases when approaching the outlet. Injecting nozzle 2 acts as an air-and-fluid injection outlet.

As FIG. 10 VIEW A-A showing, several screw grooves (941) can be drilled in a spiral pattern on inner surface of injecting nozzle 2 (94), by which fluid can be injected out as whirlpool.

And toothbrush bristle can be added on injecting nozzle 2 as in working plan 2 in FIG. 9.

Also, as FIG. 10 showing, a valve (26) can be added on cleansing fluid hose for controlling fluid flow.

Working Plan 4

In this working plan, a particle storage tube (210) is used instead of cleansing fluid container (42), as showing in FIG. 15.

Besides particle storage tube, other devices such as motor (16), diaphragm (82), nozzle section(90) and injecting nozzle 2 (92) are necessary as well.

However cleansing fluid container, cleansing fluid hose, cleansing fluid container air inlet, cleansing fluid flow adjustment valve, center of gravity, etc. are not needed.

Particle storage tube (210) is set on the inner path within nozzle section, with many holes on surface and particles (212) made of natural extracts inside. Within nozzle section the tube is supported by the framework around it.

Compressed air rises into and pass through the empty space among particles and air gab (211) and later be injected by injecting nozzle 2.

Particles stored in the tube should be those made of natural extracts such as Angelicae radix, Asiasari radix, Janthoxyli fructus. Make sure that they would not flow out of the tube through the air gab and compressed air could get through among them smoothly.

The compressed air flowing through the particles and injected by injecting nozzle 2 is discharged with natural extracts'fragrance.

### INDUSTRIAL APPLICABILITY

As described above, technical effects of the Air Injection Type Portable Dental Flosses according to the present invention as follows.

1. Developing air injection portable inter-dental toothbrush, a new inter-dental toothbrush for removing the sediments in teeth or sterilizing, in which an air injection device is adopted for infusing air to facilitate sediments removing and cleansing fluid is injected together with air under Bernoulli principle and air pressure other than water pump.

2. Offering small size air injection portable inter-dental toothbrush, insuring your oral hygiene anywhere.

3. Promoting portable inter-dental toothbrush with diaphragm which can enhance cleaning effect by increasing air flow and air pressure while deducing noise.

1. The air injection portable inter-dental toothbrush comprising:
1) driving section, including air injection pan, filter for removing foreign aerial substance from outside, pan motor for bringing in air and supplying it to air injection pan, battery as a power for driving the pan and a battery still attached bedding;
2) cleaning section, including cleansing fluid inlets and hose which is composed of a container for keeping cleansing fluid, where the cleansing fluid container is connected to the hose while the other end of the latter being attached to the center of the gravity so that the fluid inlets and hose can infuse cleansing fluid no matter how the containers position changes, a valve which can control cleansing fluid flow and a stopper by which cleansing fluid being refilled or replaced;
3) injecting section, including injecting nozzle 1 where air brought in by driving section and cleansing fluid supplied by cleaning section (20) blending and being injected;
4) inter-dental toothbrush section, including an outlet for discharging air and cleansing fluid, holes in plural numbers for injecting air and cleansing fluid perpendicularly and aslant, and injection nozzle 2 with toothbrush bristle stuck for injecting.

2. In the air injection portable inter-dental toothbrush of claim 1, driving section and cleaning section are attached by male and female screw for free separation and connection.

3. In the air injection portable inter-dental toothbrush of claim 1, nozzle section and toothbrush section are attached by male and female screw for free separation and connection.

4. In the air injection portable inter-dental toothbrush of claim 1, the speed of pan motor in driving section is devised to 3 adjustable levels.

5. In the air injection portable inter-dental toothbrush of claim 1, Inter-dental toothbrush section is a plane injection nozzle.

6. The air injection portable inter-dental toothbrush comprising:
1) driving section, including moving crankshaft which is connected to roll shaft of motor and inserted into diagram, at least a couple air inlet and outlet bringing in and discharging air, motor for bringing in air from outside and battery to drive the motor, the driving section functions by the crankshaft, which changes motor's rotative motion to back-and-forth motion, and more than 1 or 2 diaphragms;
2) cleaning section, including cleansing fluid inlets and hose which is composed of a container for keeping cleansing fluid, where the cleansing fluid container is connected to the hose while the other end of the latter being attached to the center of the gravity so that the fluid inlets and hose can get in cleansing fluid no matter how the container's position changes; air inlet on cleansing fluid container for forming air pressure in the container; a valve which can control cleansing fluid flow and a stopper, by which cleansing fluid can be replaced or refilled, air flowing into the cleansing fluid container can be adjusted, or the fluid can be kept from flowing out;
3) Nozzle section, including injecting nozzle 1, a path for air and cleansing fluid brought in by diagram's back-and-forth motion, where the cleansing fluid from cleaning section being compressed and injected; injecting nozzle 2, an air-and-fluid injecting device on the end of nozzle section; and air path on inner side of nozzle section for air flowing in;
4) inter-dental toothbrush next to nozzle section, including inter-dental toothbrush which injects cleansing fluid and air jet cap that can conduct strong injection; and
5) driving and cleaning sections are connected by male and female screw in order that they can combine and separate with each other freely.

7. The air injection portable inter-dental toothbrush comprising:
1) motor powered by battery;
2) diaphragm that changes motor's rotative motion to back-and-forth motion, bring in air through air inlet and discharge air through air outlet;
3) nozzle section with an air outlet on the bottom and injecting nozzle 1 where compressed air and cleansing fluid are mixed;
4) Cleansing fluid container next to nozzle section supplying cleansing fluid in store to cleansing fluid hose when diaphragm functions;
5) cleansing fluid hose with its lower part in cleansing fluid container and upper part penetrating nozzle section toward injecting nozzle 1;
6) Air inlet on cleansing fluid container, as an air path to connect cleansing fluid container and nozzle section and infuses part of compressed air from nozzle section into cleansing fluid container; and
7) Injecting nozzle 2, connected to the top of nozzle section, of which the inner path's cross section decreases when approaching the outlet.

8. The air injection portable inter-dental toothbrush comprising:
1) motor powered by battery;
2) diaphragm that changes motor's rotative motion to back-and-forth motion, bring in air through air inlet and discharge air through air outlet;
3) nozzle section with an air outlet on the bottom;
4) Particle storage tube, which is set on the inner path within nozzle section, with many holes on surface and particles made of natural extracts inside;
5) Injecting nozzle 2, connected to the top of nozzle section, of which the inner path's cross section decreases when approaching the outlet; the compressed air flowing through the particles and injected by injecting nozzle 2.

9. The air injection portable inter-dental toothbrush according to claim 7, in the front section of injecting section 2 above, bristle may be added in the air injection portable inter-dental toothbrush.

10. The air injection portable inter-dental toothbrush, in which by
1) a decelerating gear to slow down rotation of the motor;
2) crankshaft with one end fixed to decelerating gear, functioning as the latter's roll shaft and eccentricity; and
3) a coupling rod with one end connected to crankshaft movably and the other fixed to diaphragm film, motor and diaphragm connect with each other, and with a feature that following decelerating gear and crankshaft's rotating, coupling rod subsequently moves back-and-forth and leads to diaphragm film's expansion and compression.

11. The air injection portable inter-dental toothbrush in claim 7 additionally with several screw grooves in a spiral pattern on inner surface of injecting nozzle 2 by which fluid can be injected out as whirlpool.

12. The air injection portable inter-dental toothbrush in claim 7, in which
Air inlet on cleansing fluid container (92) on cleansing fluid container is attached to nozzle section with the upper part more projecting to nozzle section, which facilitates compressed air flowing in, in case there is no compressed air available in storage, it's necessary to adopt block board 1 (922) that can block air inlet on cleansing fluid container automatically by using spring 1 (921).

13. The air injection portable inter-dental toothbrush in claim 7, in which
In case there is no compressed air available in the upper part of cleansing fluid hose (24), block board 2 (241) is used that can block cleansing fluid hose automatically by using spring 2 (242).

14. The air injection portable inter-dental toothbrush in claim 7, in which the center of gravity leans to lower part of cleansing fluid hose, the hose bends to the lower part and cleansing fluid can flow steadily into the hose no matter whether cleansing fluid container is slope or not.

15. The air injection portable inter-dental toothbrush in claim 7, in which a valve is additionally added on cleansing fluid hose for controlling fluid flow.

16. The air injection portable inter-dental toothbrush in claim 10, in which connecting part of soft-material-made diaphragm film and coupling rod is thicker than other.

17. The air injection portable inter-dental toothbrush in claim 10, in which a bearing is set up at the connecting section of the crankshaft and coupling rod; and any other features.

18. The air injection portable inter-dental toothbrush according to claim 8, in the front section of injecting section 2 above, bristle may be added in the air injection portable inter-dental toothbrush.

19. The air injection portable inter-dental toothbrush in claim 8 additionally with several screw grooves in a spiral pattern on inner surface of injecting nozzle 2, by which fluid can be injected out as whirlpool.
